(19) United States
(12) Patent Application Publication
(10) Pub. No.: US 2009/0326971 A1
(43) Pub. Date: Dec. 31, 2009

(54) METHOD FOR MANAGING PACKAGE DELIVERY

(75) Inventors: Sandro Piccinini, Rome (IT); Marco Secchi, Rome (IT); Luigi Pichetti, Rome (IT)

Correspondence Address: IBM CORPORATION;INTELLECTUAL PROPERTY LAW, 11501 BURNET ROAD, AUSTIN, TX, 78758, US

(73) Assignee: IBM Corporation, Armonk, NY (US)

(21) Appl. No.: 12/164,892

(22) Filed: Jun. 30, 2008

(51) Int. Cl. G06Q 10/00

(52) U.S. Cl. 705/1

(57) ABSTRACT

A method for managing package delivery may include receiving a plurality of packages. Each package may include a bar code or RFID tag associating the package with personal profile information. A delivery route plan may be generated based on the personal profile information. The estimated delivery time may be transmitted to the recipient in advance of the delivery. An electronic reply communication including a location of the recipient may be received from a notified recipient either confirming the delivery or proposing an alternate delivery time or location. The delivery route plan may be recalculated based on the retrieved personal profile information, the alternate delivery time or location if proposed by the recipient, and/or the current location of the recipient to identify alternate delivery time and location options. A confirmation selecting one of the alternate delivery time and location options or reconfirming the delivery may be received from the recipient.

### FIELD

Example embodiments relate to package delivery, and for example, to a method for managing package delivery including notifying a recipient when a package will be delivered in advance of the delivery based on information associated with each package and the recipient of each package.

### BACKGROUND

As the number of purchases made using the Internet increases, the usage of carriers, (e.g., United Parcel Service (UPS), United States Postal Service (USPS), etc.), for delivering packages to recipients increases. Many carriers provide the ability to track the movement of packages between locations. A recipient may determine the general location of a purchase each day while the purchase is in transit. Accordingly, the recipient may determine the day on which the package is likely to arrive. However, the recipient is unable to know a more exact time for the delivery. As such, recipients may spend a relatively long period of time waiting to receive delivery of an order.

### SUMMARY

Example embodiments provide an integrated management system and method for package delivery. Example embodiments may reduce recipient waiting time and/or improve delivery routes of carriers based on recipient preferences, location, and/or traffic information.

According to an example embodiment, a method for managing package delivery may include receiving a plurality of packages directed to a plurality of recipients. Each package may include a bar code or RFID tag associating the package with personal profile information related to a recipient of each package. The personal profile information may include a preferred delivery time, an advance pre-delivery notification time, an address, and/or a contact number. Bar codes or RFID tags may be interrogated using a microprocessor device to retrieve the personal profile information associated with the plurality of packages. A delivery route plan may be generated based on the retrieved personal profile information. Packages having earlier preferred delivery times may be given preference in the generation of the delivery route plan. An estimated delivery time for a package may be determined using a global positioning system location device and/or traffic information. The estimated delivery time may be transmitted to notify a recipient when a package will be delivered. The estimated delivery time may be electronically transmitted to the recipient in advance of the delivery based on the recipient's advance pre-delivery notification time. An electronic reply communication may be received from a notified recipient either confirming the delivery, proposing an alternate delivery time or proposing an alternate delivery location. The electronic reply communication may include a current location of the notified recipient. The delivery route plan may be recalculated based on the retrieved personal profile information, the alternate delivery time or location if proposed by the recipient, and/or the current location of the notified recipient to identify alternate delivery time and location options. The alternate delivery time and location options may be transmitted to the notified recipient. A confirmation selecting one of the alternate delivery time and location options or reconfirming the delivery may be received from the recipient. An electronic communication may be transmitted to the notified recipient either accepting or rejecting the selection by the recipient.

### DESCRIPTION OF THE FIGURES

FIG. 1 is a diagram illustrating an example system for managing package delivery according to an example embodiment; and

FIG. 2 is a flow-chart illustrating a method for managing package delivery using the system of FIG. 1.

### DETAILED DESCRIPTION

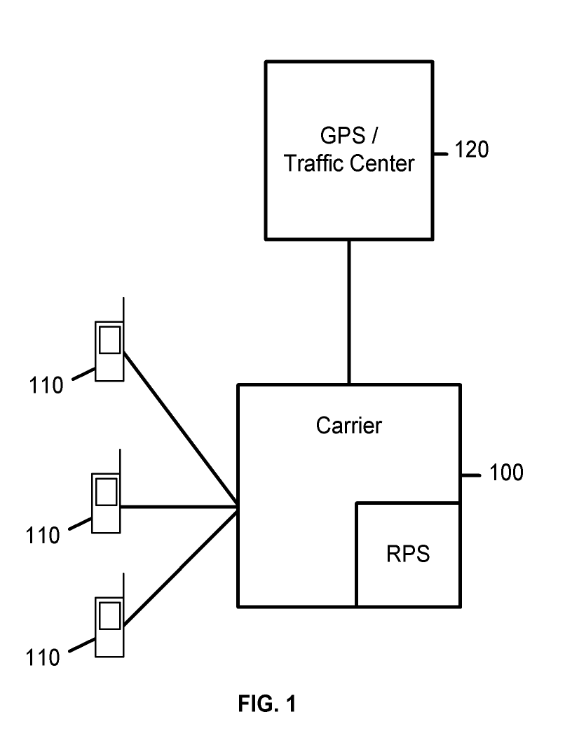

As illustrated in FIG. 1, a system for managing package delivery may include a carrier 100, recipients 110, and/or a Global Positioning System (GPS)/traffic information center 120.

The carrier 100 may receive and transport packages directed to the recipients 110. Each package may include a bar code or a radio frequency identification (RFID) tag. The bar code or RFID tag may store personal profile information, (e.g., entered by the recipient 110 or carrier 100), related to a recipient 110 of each package. For example, the bar code or RFID tag may store the personal profile information internally. Alternatively, the bar code or RFID tag may associate the package with personal profile information stored in an external database. The personal profile information may include an address, a preferred delivery time, an advance pre-delivery notification time indicating an amount of time before delivery of the package that the recipient 110 should be notified, and/or a contact number of the recipient 110 waiting for delivery of the package. The address, preferred delivery time, and/or advance pre-delivery notification time may be set by the recipient 110 during purchasing or scheduling of delivery. The contact number may be a telephone number or other electronic method of contacting the recipient 1 10, and/or the recipient 110 may provide the carrier 100 with the contact number upon purchase or scheduling delivery of the package. Accordingly, the carrier 100 may notify the recipient 110 a desired, or alternatively, a predetermined time in advance that the package will be delivered at a particular time.

The carrier 100 may include a route planning system configured to interrogate the bar codes or RFID tags to retrieve the personal profile information. The route planning system may interrogate the bar codes or RFID tags to provide a driver for the carrier 100 with a suggested delivery route plan based on the personal profile information of each package. The delivery route plan may be an order in which the packages are to be delivered and include a route for the carrier 100 between each package delivery location. The route planning system may interrogate the bar codes or RFID tags at desired, or alternatively, predetermined intervals, (e.g., each day). The route planning system may generate the delivery route based on the time constraints associated with each package such that packages with later or no preferred delivery times are delivered later or in a manner which more efficiently delivers the packages having preferred delivery times.

FIG. 1 illustrates the GPS/traffic information center 120 located together in a single device; however, example embodiments are not limited thereto and the GPS and traffic information center may be located in separate devices. The route planning system may be a microprocessor device, for example, a component of a GPS unit carried by a driver of the carrier 100 configured to interact with a satellite navigator and a communications system, (e.g., a wireless telecommunications network).

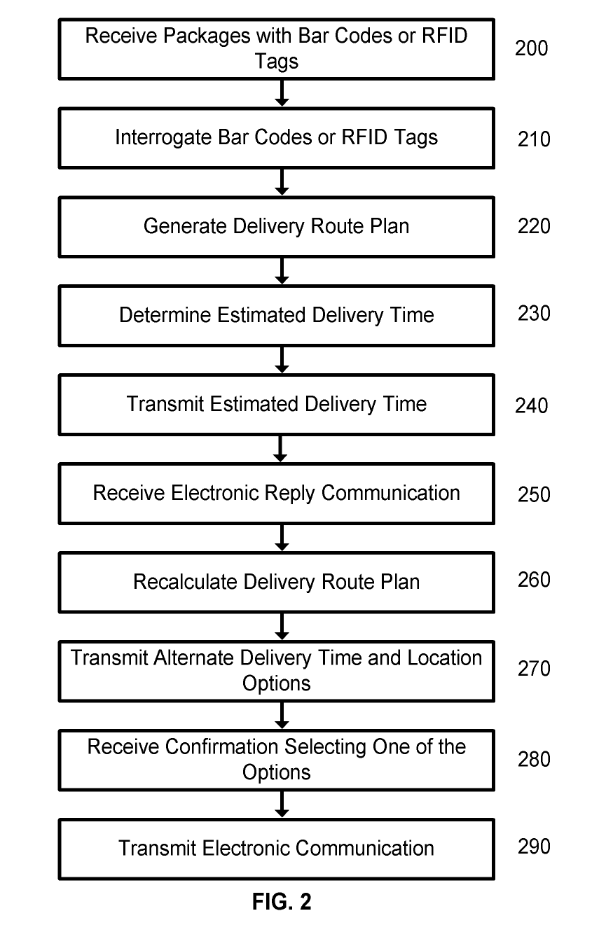

As illustrated in FIG. 2, the carrier 100 may receive a plurality of packages directed to a plurality of recipients 110 at step 200. At step 21 0, the carrier 100 may interrogate the bar codes or RFID tags using the microprocessor device to retrieve the personal profile information associated with the plurality of packages. At step 220, the microprocessor device of the carrier 100 may generate a delivery route plan based on the retrieved personal profile information. At step 230, the microprocessor device may determine an estimated delivery time for a package using the GPS device and/or traffic information. At step 240, the carrier 100 may transmit the estimated delivery time to notify a recipient 110 when a package will be delivered. The estimated delivery time may be electronically transmitted to the recipient 110 in advance of the delivery based on the advance pre-delivery notification time of the recipient 110. For example, before the delivery of each package the microprocessor device may verify the preferred delivery time and/or advance pre-delivery time and use the communications system to send the electronic communication to the recipient 110, (e.g, in the form of a short message service (SMS) message, email, voicemail, phone call, etc). However, if the carrier 100 determines the estimated delivery time to be different from the preferred delivery time the carrier 100 may adjust the timing of the electronic communication accordingly.

At step 250, the carrier 100 may receive an electronic reply communication from a notified recipient 110 either confirming the delivery, proposing an alternate delivery time, or proposing an alternate delivery location. The electronic reply communication from the notified recipient 110 may include additional information, for example, a location of the recipient, (e.g., GPS coordinates). At step 260, the microprocessor device of the carrier 100 may recalculate the delivery route plan based on the retrieved personal profile information, the alternate delivery time or location if proposed by the recipient, and/or the current location of the notified recipient 110 to identify alternate delivery time and location options. The carrier 100 may include an additional monetary charge for the alternate delivery time and location options.

The carrier 100 may recalculate the delivery route plan to determine the alternate delivery time and location options even if the recipient 110 did not propose an alternate delivery time or location. For example, the carrier 100 may receive an electronic reply communication from the notified recipient 110 confirming the delivery and including a location of the recipient which is different from the confirmed delivery location. The carrier 100 may recalculate the delivery route plan to determine delivery locations and times at or nearer to the current location of the recipient 110. Accordingly, the carrier 100 may provide the recipient 110 with alternate delivery time and location options that the recipient may not have proposed or considered. Alternatively, if the recipient 110 proposes an alternate delivery time or location, the carrier 100 may recalculate the delivery route plan to determine if the alternate delivery locations and times proposed by the recipient are acceptable and/or to determine additional delivery locations and times at or nearer to the current location of the recipient 1 10.

At step 270, the carrier 100 may transmit the alternate delivery time and location options to the notified recipient 110. Accordingly, the recipient 110 may choose between proposed location options based on the preferences of the recipient 110 and other options based on a current location of the recipient 110 that the recipient may not have otherwise proposed. At step 280, the carrier 100 may receive a confirmation selecting one of the alternate delivery time and location options or reconfirming the original delivery from the recipient 110. For example, if none of the proposed alternate delivery time and location options are suitable to the recipient 110, the recipient 110 may reconfirm the original delivery route plan. Alternatively, one of the proposed alternate delivery time and location options which better suits the needs of the recipient 110 may be selected. The confirmation may include an authorization for any additional charges required by the carrier 100 for a selected alternate delivery time and location option.

At step 290, the carrier 100 may transmit an electronic communication to the notified recipient 110 either accepting or rejecting the selection by the recipient 110. If the carrier 100 accepts the selection by the recipient 110, the carrier 100 may implement a recalculated delivery route plan corresponding to the alternate delivery time and location option selected by the recipient 110. Accordingly, estimated delivery times for the remainder of the packages along the delivery route plan may be adjusted by the recalculated delivery route plan. If the carrier 100 rejects the selection by the recipient 110, the carrier 100 may attempt to reschedule delivery with the recipient 110 using the above process to propose alternate delivery time and location options or the carrier 100 may reinstitute the original delivery route plan.

Accordingly, a system and method for managing package delivery according to example embodiments may reduce an amount of time spent by a recipient waiting for a package to be delivered. A carrier may use a system and method according to example embodiments to improve delivery routes based on recipient preferences, location, and/or traffic information.

Although specific example embodiments have been disclosed, a person skilled in the art will understand that changes can be made to the specific example embodiments without departing from the spirit and scope of the invention.

What is claimed is:

1. A method for managing package delivery comprising:
receiving a plurality of packages directed to a plurality of recipients, wherein each package includes a bar code or RFID tag associating the package with personal profile information related to a recipient of each package, wherein the personal profile information includes a preferred delivery time, an advance pre-delivery notification time, an address and a contact number;
interrogating bar codes or RFID tags using a microprocessor device to retrieve the personal profile information associated with the plurality of packages;
generating a delivery route plan based on the retrieved personal profile information, wherein packages having earlier preferred delivery times are given preference in the generation of the delivery route plan;
determining an estimated delivery time for a package using a global positioning system location device and traffic information;
transmitting the estimated delivery time to notify a recipient when a package will be delivered, wherein the estimated delivery time is electronically transmitted to the recipient in advance of the delivery based on the recipient's advance pre-delivery notification time;
receiving an electronic reply communication from a notified recipient either confirming the delivery, proposing an alternate delivery time or proposing an alternate delivery location, the electronic reply communication including a current location of the notified recipient;
recalculating the delivery route plan based on the retrieved personal profile information, the alternate delivery time or location if proposed by the recipient, and the current location of the notified recipient to identify alternate delivery time and location options;
transmitting the alternate delivery time and location options to the notified recipient;
receiving a confirmation selecting one of the alternate delivery time and location options or reconfirming the delivery from the recipient; and
transmitting an electronic communication to the notified recipient either accepting or rejecting the selection by the recipient.
